(19) United States
(12) Patent Application Publication
(10) Pub. No.: US 2017/0124271 A1
(43) Pub. Date: May 4, 2017

(54) METHOD AND SYSTEM FOR SHARING, DISTRIBUTING, RANKING, AND SEARCHING MEDICAL DEVICE CONFIGURATION ITEMS

(71) Applicant: General Electric Company, Schenectady, NY (US)

(72) Inventors: Svein Arne Aase, Trondheim (NO); Morgan Jakobsen, Horten (NO)

(21) Appl. No.: 14/926,660

(22) Filed: Oct. 29, 2015

(51) Int. Cl. G06F 19/00

(52) U.S. Cl. CPC G06F 19/3406

(57) ABSTRACT

Various embodiments include a system and method for sharing, distributing, ranking, and searching medical device configuration items. The method can include receiving a request, transmitted over a network to a server, to search medical configuration items stored at the server. Each of the medical configuration items may be associated with a rating. Each of the medical configuration items may be applied to perform a medical task. The method may include providing, by the server, a list of relevant medical configuration items based on the search request. The relevant medical configuration items may be listed in an order based on the rating. The method can include receiving a selection, at the server, of one of the relevant medical configuration items provided in the list. The method may include distributing, by the server, the selected one of the relevant medical configuration items over the network.

### CROSS-REFERENCE TO RELATED APPLICATIONS/INCORPORATION BY REFERENCE

[Not Applicable]

### FIELD OF THE INVENTION

Certain embodiments of the invention relate to medical device configuration items, such as imaging device operating parameters and templates, measurement definitions, and report templates. More specifically, certain embodiments of the invention relate to a method and system for providing a social network to facilitate user sharing, distributing, ranking, and searching medical device configuration items.

### BACKGROUND OF THE INVENTION

Medical devices, such as ultrasound, magnetic resonance imaging (MRI), computed tomography (CT), digital radiography, and/or X-ray imaging modalities, operate according to various parameters and may use various templates, many of which are user-definable. Medical workstations may be used with medical imaging modalities to perform measurements on image data and prepare reports on the acquired image data. The measurements and report templates are often user-definable. For example, a user of an ultrasound system may set various parameters, such as image depth, image width, focus position, number of foci, line density, transmission pulse pattern, region of interest, and the like. The user may additionally or alternatively create a template, such as a stress echocardiography template that defines the stress stages and image views that should be acquired at each stress stage. The user can employ image processing and/or filtering algorithms to process acquired image data. The user may perform various measurements on the image data based on measurement tools and other available measurements, such as long bone measurements, vessel thickness measurements, fetal head measurements, and the like. The measurements may be created and/or otherwise defined by the user based on the measurement tools available. The user may report findings from the medical image examination in a report template, the appearance of which may be customized for a particular user.

Typically, a user may store created imaging device operating parameters, examination templates, measurement definitions, and report templates locally at an imaging modality or medical workstation, or on a portable data storage device, such as a memory stick or flash drive that can be inserted into an imaging modality or medical workstation to access the user's stored parameters and templates. Accordingly, these configuration items may not be readily available to users at different machines. Moreover, it is difficult to share, distribute, identify, recommend, and/or provide feedback regarding configuration items.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for sharing, distributing, ranking, and searching medical device configuration items, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary medical environment configured to provide sharing, distribution, ranking, and searching of medical device configuration items, in accordance with an embodiment of the invention.

FIG. 2 is a flow chart illustrating exemplary steps that may be utilized for sharing configuration items, in accordance with an embodiment of the invention.

FIG. 3 is a flow chart illustrating exemplary steps that may be utilized for searching, distributing, and ranking configuration items, in accordance with an embodiment of the invention.

FIG. 4 is a flow chart illustrating exemplary steps that may be utilized for retrieving configuration items, in accordance with an embodiment of the invention.

### DETAILED DESCRIPTION OF THE INVENTION

Certain embodiments of the invention may be found in a method and system for sharing, distributing, ranking, and searching medical device configuration items. More specifically, aspects of the present invention have the technical effect of providing a social network to improve accessibility and feedback related to medical device configuration items, such as imaging device operating parameters and templates, measurement definitions, and report templates, by facilitating user sharing, distribution, rating, and searching of the medical device configuration items.

The foregoing summary, as well as the following detailed description of certain embodiments will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or a block of random access memory, hard disk, or the like) or multiple pieces of hardware. Similarly, the programs may be stand alone programs, may be incorporated as subroutines in an operating system, may be functions in an installed software package, and the like. It should be understood that the various embodiments are not limited to the arrangements and instrumentality shown in the drawings. It should also be understood that the embodiments may be combined, or that other embodiments may be utilized and that structural, logical and electrical changes may be made without departing from the scope of the various embodiments of the present invention. The following detailed description is, therefore, not to be taken in a limiting sense, and the scope of the present invention is defined by the appended claims and their equivalents.

As used herein, an element or step recited in the singular and proceeded with the word “a” or “an” should be understood as not excluding plural of said elements or steps, unless such exclusion is explicitly stated. Furthermore, references to “an embodiment,” “one embodiment,” “a representative embodiment,” “an exemplary embodiment,” “various embodiments,” “certain embodiments,” and the like are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional elements not having that property.

Furthermore, the term processor or processing unit, as used herein, refers to any type of processing unit that can carry out the required calculations needed for the invention, such as single or multi-core: CPU, Graphics Board, DSP, FPGA, ASIC or a combination thereof.

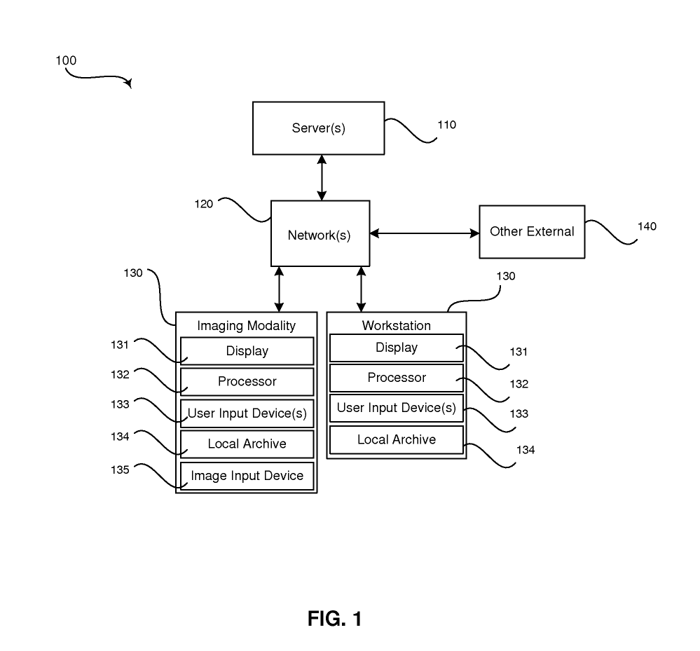

It should be noted that various embodiments are described herein with reference to operating parameters and templates of imaging modalities, such as an ultrasound system. For example, FIG. 1 illustrates an exemplary medical environment comprising an imaging modality. However, aspects of the present invention are not limited to imaging modalities. Instead, any medical device having configurable operating parameters, examination templates, measurement definitions, and/or report templates is contemplated. Moreover, in imaging modality embodiments, the imaging modality may be any suitable imaging modality, such as ultrasound, magnetic resonance imaging (MRI), computed tomography (CT), digital radiography, X-ray, and the like.

FIG. 1 is a block diagram of an exemplary medical environment 100 configured to provide sharing, distribution, ranking, and searching of medical device configuration items, in accordance with an embodiment of the invention. Referring to FIG. 1, the environment 100 includes one or more servers 110, one or more networks 120, medical devices 130, and external systems and applications 140. The server(s) 110 may be interconnected, and may singly or as a group be connected to a network 120, such as the Internet, for example, via any suitable combination of wired or wireless data communication links. For example, the network 120 may connect medical devices 130 in a hospital or across multiple hospitals to the server(s) 110. The server(s) 110 may be capable of executing any of the method(s) and/or set(s) of instructions discussed below in accordance with the present invention, for example. In certain embodiments, the server(s) 110 comprise suitable logic, circuitry, interfaces and/or code that may be operable to store and provide configuration items and associated ratings, subscriptions, recommendations, and user preferences to and/or from the medical devices 130 in response to user inputs received from user input device(s) 133 of the medical devices 130 and provided to server(s) 110, for example. In various embodiments, the medical environment 100 may not include server(s) 110 and can instead be implemented as a serverless peer-to-peer environment where the medical devices 130 store and directly communicate the configuration items and associated information. The external systems and applications 140 may be interconnected, and may singly or as a group be connected to a network 120, such as the Internet, for example, via any suitable combination of wired or wireless data communication links.

The medical devices 130 comprise suitable logic, circuitry, interfaces and/or code that may be operable to perform medical imaging scans, perform measurements and medical image post-processing, and/or generate medical reports. The medical devices 130 are connected to the network 120 by any suitable combination of wired or wireless data communication links. The medical devices 130 may include imaging modalities, such as ultrasound, magnetic resonance imaging (MRI), computed tomography (CT), digital radiography, X-ray, or any suitable medical imaging system. The medical devices 130 may include medical workstations. The medical workstations can be embodied in any of, for example, a desktop computer, a laptop computer, a notebook computer, a netbook computer, a tablet computer, a mobile phone, or any other electronic device having capabilities suitable for accessing the network 12. In various embodiments, the medical devices 130 may include one or more of a display 131, a processor 132, user input device(s) 133, memory 134, and an image input device 135, among other things. Components of the medical devices 130 may be implemented in software, hardware, firmware, and/or the like. The various components of the medical devices 130 may be communicatively linked. Components of the medical devices 130 may be implemented separately and/or integrated in various forms. For example, the display 131 and the user input device(s) 133 may be integrated as a touchscreen display.

The user input device(s) 133 comprise suitable logic, circuitry, interfaces and/or code that may be operable to communicate information from a user and/or at the direction of the user to the processor 132 of the medical device 130, for example. The user input device(s) 133 may include button(s), a touchscreen, motion tracking, voice recognition, a mousing device, keyboard, camera and/or any other device capable of receiving a user directive. In certain embodiments, one or more of the user input devices 133 may be integrated into other components, such as the display 131, for example. As an example, user input device 133 may include a touchscreen display. In various embodiments, the user input module 140 may provide imaging device operating parameters and templates, measurement definitions, and report templates to the processor 120. The imaging device operating parameters and templates may be used to operate the image input device 135 to acquire image data, for example. The measurement definitions may be used to perform measurements on acquired image data. The report templates may be used to generate medical reports.

The display 131 comprises suitable logic, circuitry, interfaces and/or code that may be operable to communicate visual information to a user. For example, a display 131 may include one or more monitors comprising a liquid crystal display, a light emitting diode display, and/or any suitable display. The display 131 can be operable to display medical image data, imaging device operating parameters and templates, measurement definitions, medical report templates, or any suitable information. In various embodiments, the display 131 may display information provided by the processor 132, for example.

The processor 132 comprises suitable logic, circuitry, interfaces and/or code that may be operable to execute software applications, receive input information from user input device(s) 133 and image input device 135, and generate an output displayable by a display 131, among other things. For example, the processor 132 may be operable to control a medical imaging scan and generate medical images for display, perform measurements and medical image post-processing, and generate medical reports in response to user inputs received from the user input device(s) 133. The processor 132 may be one or more central processing units, microprocessors, microcontrollers, and/or the like. The processor 132 may be an integrated component, or may be distributed across various locations, for example. The processor 132 may be capable of executing any of the method(s) and/or set(s) of instructions discussed below in accordance with the present invention, for example. In certain embodiments, the processor 132 may be operable to receive and store configuration items, perform tasks based on the configuration items, provide configuration items to the server(s) 110 for sharing, request searches of the configuration items stored at the server(s) 110, request distribution of configuration items stored at the server(s) 110, provide user ratings, subscriptions, and recommendations for a configuration item to the server(s) 110, and update a local archive 134 with configuration items stored at the server(s) 110 based on user preferences, for example.

In various embodiments, the information provided by the user input device(s) 133 to the processor 132 may be processed by the processor 132 to control one or more applications for creating and storing configuration items, sharing configuration items, updating configuration items, controlling medical image data acquisition based on user-configurable imaging device operating parameters and templates, generating medical images based on acquired medical image data, performing user-configurable measurements and post-processing of medical images, and generating medical reports based on user-configurable report templates, for example. As an example, button depressions, touchscreen selections, mousing inputs, keyboard inputs, and/or voice commands, among other things, may be received from the user input device(s) 133 and processed by the processor 132 to create, share, rate, recommend, subscribe, select, and/or execute configuration items, for example.

The local archive 134 comprises suitable logic, circuitry, interfaces and/or code that may be operable to store configuration items, such as imaging device operating parameters and templates, measurement definitions, and report templates, medical image data, software applications, and any other suitable information. The local archive 134 may be one or more computer-readable memories, for example, such as a hard disk, floppy disk, CD, CD-ROM, DVD, compact storage, flash memory, random access memory, read-only memory, electrically erasable and programmable read-only memory and/or any suitable memory. The local archive 134 may include databases, libraries, sets of information, or other storage accessed by and/or incorporated with the processor 132, for example. The local archive 132 may be able to store data temporarily or permanently, for example. The local archive 132 may be capable of storing data generated by the processor 132 and/or instructions readable by the processor 132, among other things.

The image input device 135 comprises suitable logic, circuitry, interfaces and/or code that may be operable to capture an image of a patient anatomy. For example, the image input device 135 may include an ultrasound scanner, magnetic resonance imager, X-ray imager, or the like. The image input device 135 acquires image data in response to operating parameters and instructions communicated by processor 132 to the image input device 135. The image data representative of acquired image(s) is communicated from the image input device 135 to the processor 132. The operating parameters, instructions, and image data may be communicated electronically over a wired or wireless connection, for example.

In operation, a user may log onto a medical device 130 in a medical environment 100. For example, the user may provide a user name and password or perform any suitable log on procedure, such as facial recognition, voice recognition, signature recognition, DNA, retinal scanning, iris recognition, fingerprint, hand geometry, or the like. The medical device 130, which may be connected to server(s) 110 over network(s) 120 or may be implemented in a serverless peer-to-peer environment, may automatically acquire configuration items based on user preferences and/or administrator instructions. For example, a user may be following or subscribed to a set of imaging device operating parameters. The most recent version of the set of imaging device operating parameters may automatically be downloaded to the medical device local archive 134 once the user is logged into the medical device 130. Additionally and/or alternatively, a notification may be sent to the user that an update is available for download. Moreover, while the user is logged into the medical device 130, the server(s) 110 may provide updates of the set of imaging device operating parameters to the medical device 130 such that the user has the most up to date version of the parameters. As another example, an administrator may provide instructions directing the server(s) 110 to provide or the medical devices 130 to request a particular configuration item, such as a medical report template for a particular user or group of users to receive when logged on to a medical device 130.

The user, once logged into the medical device 130, may create or configure configuration items by providing user inputs to the medical device processor 132 via user input device(s) 133. For example, the user may use a keyboard 133 to enter a set of imaging device operating parameters, imaging examination templates, measurement definitions, and/or report templates, among other things. The created configuration item may be stored by the processor 132 at a local archive 134. The processor 132 may access the local archive 134 to retrieve the configuration item for application when the user performs a task, such as acquiring image data, performing a measurement, or generating a medical report, for example. In various embodiments, the user may share the configuration item with other users. The processor 132 of the medical device 130 may upload the configuration item to the server(s) 110 based on a user instruction to share the configuration item. The shared configuration item may be provided with information provided by a user or the processor 132 of the medical device based on the application. For example, a user and/or a processor 132 may provide a title and description of the configuration item, a device type (e.g., ultrasound, magnetic resonance, computed tomography, X-ray), a model and/or probe type, an examination type, and/or any suitable information related to the configuration item. The user may also provide a recommendation of the configuration for a particular user or group of users. The identified user or group of users may receive a message regarding the recommendation and/or the configuration item may automatically be provided to the identified user or group of users based on the recommendation. The server(s) 110 store the shared configuration item and related information for search, display, and distribution to other medical device users.

Still referring to FIG. 1, a user of a medical device 130 may initiate a search of the server(s) 110 for shared configuration items. For example, a user performing a nuchal translucency examination may search for imaging device operating parameters, imaging examination templates, measurement definitions, and report templates configured for a nuchal translucency examination. The configuration items may be listed based on relevance, an assigned rating, or any suitable information. For example, a user searching for imaging device operating parameters optimized for a nuchal translucency examination may view relevant configuration items based on a highest rating (e.g., between 1 and 5 stars), a number of received likes, a number of subscribers/followers, or the like. The user may review the configuration item titles, descriptions, and ratings and select one of the configuration items for download from the server(s) 110 to the medical device local archive 134. The processor 132 of the medical device 130 may access the local archive 134 to retrieve the configuration item for application when the user performs the nuchal translucency imaging examination, for example. The user may provide a rating for the configuration item, for example, based on the user's experience applying the configuration item. As an example, the user may select a “like” button associated with the configuration file, assign a grade (e.g., A-F), assign a number rating (e.g., 1-10), assign a number of stars (e.g., 1-5 stars), and/or any suitable rating system. In various embodiments, the rating may be based on more than one rating mechanism, such as the number of “likes” and a number of stars, or any suitable combination of rating mechanisms. The rating may be provided by the processor 132 of the medical device 130 to the server(s) 110, such that the server(s) may update a rating associated with the particular configuration item. Additionally and/or alternatively, the user may subscribe/follow a particular configuration item and/or recommend the configuration item to another user or group of users. For example, the user may subscribe/follow a particular configuration item so that the user receives and/or is notified of the most recent version of the configuration item if it is updated. As another example, the user may recommend a set of ultrasound operating parameters for a nuchal translucency examination to obstetric ultrasound technicians.

Accordingly, the medical environment 100 described in connection with FIG. 1 provides a social network to improve accessibility and feedback related to medical device configuration items by facilitating user sharing, distribution, rating, and searching of the medical device configuration items.

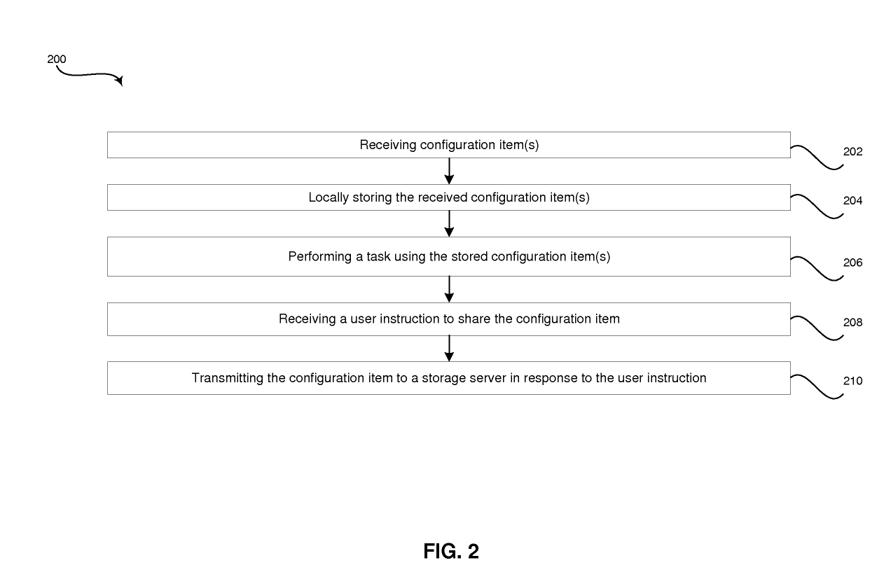

FIG. 2 is a flow chart 200 illustrating exemplary steps that may be utilized for sharing configuration items, in accordance with an embodiment of the invention. Referring to FIG. 2, there is shown a flow chart 200 comprising exemplary steps 202 through 210. Certain embodiments of the present invention may omit one or more of the steps, and/or perform the steps in a different order than the order listed, and/or combine certain of the steps discussed below. For example, some steps may not be performed in certain embodiments of the present invention. As a further example, certain steps may be performed in a different temporal order, including simultaneously, than listed below.

In step 202, a medical device 130 receives a configuration item. A configuration item may include imaging device operating parameters, imaging examination templates, image measurement definitions, medical report templates, or the like. A user may create and/or otherwise provide a processor 132 of the medical device 130 the configuration item via a user input device 133, such as a keyboard, mousing device, touch screen input, or any suitable input device. For example, a user may configure imaging device operating parameters, such as image width, image depth, focus position, number of foci, gain, and the like by entering the parameters at a keyboard 133 of the medical device 130. In step 204, the configuration item may be stored at a local archive 134 of the medical device 130. For example, the configuration item provided at step 202 to the processor 132 of the medical device 130 may be stored by the processor 132 at the local archive 134.

In step 206, the user may perform a task at the medical device 130 using the stored configuration item. For example, the processor 132 and/or image input device 135 of an imaging modality 130 may execute stored imaging device operating parameters and/or imaging examination templates to acquire image data. As another example, the processor 132 of an imaging modality 130 or medical workstation 130 may execute stored measurement definitions to perform measurements on acquired or retrieved image data. Furthermore, the processor 132 of a medical workstation 130 may retrieve a report template for generating a medical report.

In step 208, the processor 132 of the medical device 130 receives a user instruction to share the configuration item. For example, the user of the medical device 130 may provide an instruction via a user input device 133 to share the configuration item. By sharing the configuration item, the user may access the configuration item from other medical devices 130 without having to recreate the configuration item or carry a portable data storage device, such as a memory stick or flash drive, to access the configuration item. Moreover, the configuration item may be accessible for use by other users in the medical environment 100.

In step 210, the processor 132 of the medical device 130 transmits the configuration item to server(s) 110 for storage. The shared configuration item may be provided with information provided by a user or the processor 132 of the medical device based on the application. For example, a user and/or a processor 132 may provide a title and description of the configuration item, a device type (e.g., ultrasound, magnetic resonance, computed tomography, X-ray), a model and/or probe type, an examination type, and/or any suitable information related to the configuration item. The user may also provide a recommendation of the configuration for a particular user or group of users. The identified user or group of users may receive a message regarding the recommendation and/or the configuration item may automatically be provided to the identified user or group of users based on the recommendation. The server(s) 110 store the shared configuration item and related information for search, display, and distribution to any medical device users or a selected authorized group of medical device users, for example.

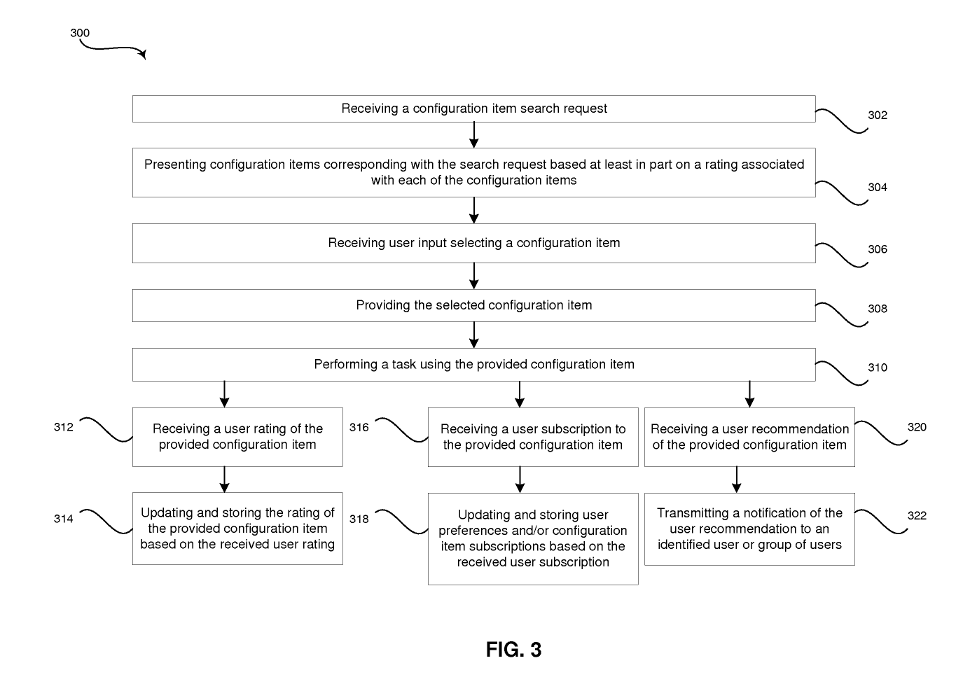

FIG. 3 is a flow chart 300 illustrating exemplary steps that may be utilized for searching, distributing, and ranking configuration items, in accordance with an embodiment of the invention. Referring to FIG. 3, there is shown a flow chart 300 comprising exemplary steps 302 through 322. Certain embodiments of the present invention may omit one or more of the steps, and/or perform the steps in a different order than the order listed, and/or combine certain of the steps discussed below. For example, some steps may not be performed in certain embodiments of the present invention. As a further example, certain steps may be performed in a different temporal order, including simultaneously, than listed below.

In step 302, a processor 132 of a medical device 130 and/or server(s) 110 receive a configuration item search request. For example, a user of a medical device 130 may initiate a search of the server(s) 110 for shared configuration items. The user may enter search parameters, such as an imaging modality type, an examination type, a measurement type, a report type, or the like at a user input device 133. The processor 132 of the medical device 130 may receive the request and query server(s) 110. The server(s) 110 may provide a list of suitable configuration items for presentation at display 131 of the medical device 130.

In step 304, configuration items corresponding with the search request may be presented at a display 131 of the medical device 130 based at least in part on relevance, an assigned rating, or any suitable information. For example, a user performing a nuchal translucency examination that searched for imaging device operating parameters of a nuchal translucency examination may view relevant configuration items listed in an order based on a highest rating (e.g., between 1 and 5 stars, between 1-10, between A-F), a number of received likes, a number of subscribers/followers, or the like.

In step 306, a user may select a configuration from the list presented at the display 131 of the medical device 130. For example, the user may review the configuration item titles, descriptions, and ratings and select one of the configuration items for download from the server(s) 110 to the medical device local archive 134. The user may provide the selection to the processor 132 of the medical device 130 via a user input device 133. In step 308, the server(s) 110 provide the selected configuration item to the requesting medical device 130. For example, the server(s) 110 may distribute the shared configuration item to the processor 132 of the requesting medical device 130. The processor 132 may store the received configuration item in the local archive 134 of the medical device 130, for example.

In step 310, the medical device 130 may perform a task that applies the selected configuration item received at step 308. For example, the processor 132 of the medical device 130 may access the local archive 134 to retrieve a report template configuration item for application when a user is generating a medical report. As another example, the processor 132 and/or an image input device 135 of the medical device 130 may retrieve imaging operating parameters and/or an examination template configuration item(s) from the archive 134 for application when acquiring image data. Furthermore, the processor 132 of the medical device 130 may retrieve and apply a measurement configuration item when performing measurements on acquired or retrieved image data.

In step 312, a user rating for a particular configuration item is received. For example, the user may provide a rating for the configuration item. The rating may be provided to a processor 132 of the medical device from a user input device 133. The rating may be based on, for example, the user's experience applying the configuration item when performing a task. As an example, the user may select a “like” button associated with the configuration file, assign a grade (e.g., A-F), assign a number rating (e.g., 1-10), assign a number of stars (e.g., 1-5 stars), or any suitable rating system. The rating may be provided by the processor 132 of the medical device 130 to the server(s) 110, such that the server(s) may update a rating associated with the particular configuration item. In step 314, the server(s) 110 update and store the rating of the provided configuration item based on the received user rating. For example, the server(s) 110 may tally an additional “like” for a particular configuration item or calculate a revised rating by averaging an assigned star rating with previous star ratings. The updated rating for a particular configuration item may affect the listing position of the configuration item in future searches. For example, if two users previously rated a configuration item as five stars and a current user rated the configuration item as two stars, the revised rating of four stars (i.e., the average of the three ratings) may lower the configuration item's listing position below other related five star configuration items.

In step 316, a user subscription for a particular configuration item is received. For example, a user may subscribe/follow a particular configuration item so that the user receives and/or is notified of the most recent version of the configuration item if it is updated. Specifically, subscribing or following an item may place the user on a list to receive updates, revisions, notifications, and the like regarding the configuration item. The user subscription may be provided at a user input device 133 to a processor 132 of a medical device 130, for example. The processor 132 of the medical device 130 may provide the subscription request to server(s) 110. In step 318, the server(s) 110 update and store user preferences and/or configuration item subscriptions based on the user subscription request received at step 316. For example, the server(s) 110 may revise subscription information in a user preferences profile associated with the user that is stored at the server(s) 110 and/or add the user to a list of subscribers for a particular configuration item that is separately maintained or maintained with the configuration item, among other things.

In step 320, a user recommendation of a particular configuration item is received. For example, a user may recommend the configuration item to another user or group of users. The recommendation may be provided at a user input device 133 to a processor 132 of a medical device 130. The processor 132 of the medical device 130 may provide the recommendation to server(s) 110. As an example, the user may recommend a set of ultrasound operating parameters for a nuchal translucency examination to obstetric ultrasound technicians. In step 322, the server(s) 110 may transmit a notification of the user recommendation and/or the configuration item that was recommended to the identified user or group of users. For example, the server(s) 110 may automatically distribute the recommended configuration item to the user(s) in response to the recommendation. Additionally and/or alternatively, the server(s) may send a message, such as an electronic mail message, a text message, an automated voice message, or the like to the recommended user(s)′ electronic mail account 140, mobile phone 140, or a medical device 130 where the user(s) are logged in. The message may provide a link or otherwise identify the configuration item retrievable from the server(s) 110.

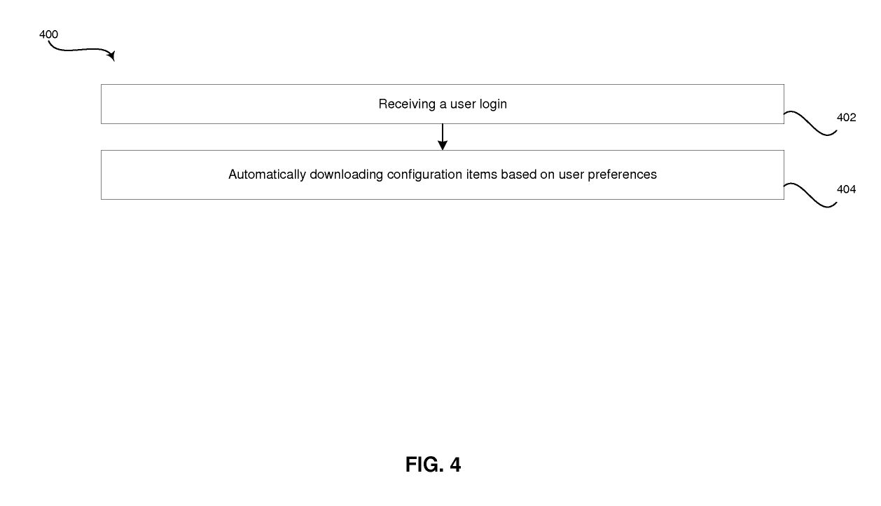

FIG. 4 is a flow chart 400 illustrating exemplary steps that may be utilized for retrieving configuration items, in accordance with an embodiment of the invention. Referring to FIG. 4, there is shown a flow chart 400 comprising exemplary steps 402 through 404. Certain embodiments of the present invention may omit one or more of the steps, and/or perform the steps in a different order than the order listed, and/or combine certain of the steps discussed below. For example, some steps may not be performed in certain embodiments of the present invention. As a further example, certain steps may be performed in a different temporal order, including simultaneously, than listed below.

In step 402, a user may log in to the medical environment 100 at a medical device 130. For example, the user may provide a user name and password or perform any suitable log on procedure, such as facial recognition, voice recognition, signature recognition, DNA, retinal scanning, iris recognition, fingerprint, hand geometry, or the like. In step 404, the processor 132 of a medical device 130 or server(s) 110 may automatically download configuration items to the local archive 134 of the medical device 130 based at least in part on user preferences and/or administrator instructions. For example, a user may be following or subscribed to a set of imaging device operating parameters. The most recent version of the set of imaging device operating parameters may automatically be downloaded to the medical device local archive 134 once the user is logged into the medical device 130. The server(s) 110 may provide updates of the set of imaging device operating parameters to the medical device 130 while the user is logged into the medical device 130, such that the user has the most up to date version of the parameters. As another example, an administrator may provide instructions directing the server(s) 110 to provide or the medical devices 130 to request a particular configuration item, such as a medical report template for a particular user or group of users to receive when logged on to a medical device 130.

Aspects of the present invention provide a system 100 and method 200, 300, 400 for sharing, distributing, ranking, and searching medical device configuration items. In accordance with various embodiments of the invention, a method 200, 300, 400 comprises receiving 302 a request, transmitted over a network 120 to a server 110, to search a plurality of medical configuration items stored at the server 110. Each of the plurality of medical configuration items may be associated with a rating. Each of the plurality of medical configuration items may be applicable to perform a medical task. The method 200, 300, 400 comprises providing 304, by the server 110, a list of relevant medical configuration items from the plurality of medical configuration items based on the search request. The relevant medical configuration items are listed in an order based on the rating. The method 200, 300, 400 comprises receiving 306 a selection, at the server 110, of one of the relevant medical configuration items provided in the list. The method 200, 300, 400 comprises distributing 308, by the server 110, the selected one of the relevant medical configuration items over the network 120.

In a representative embodiment, the request and the selection is provided by at least one user input device 133 of a medical device 130. In various embodiments, the medical device 130 is at least one of a medical imaging modality and a medical workstation. In certain embodiments, the method 200, 300, 400 comprises performing 310, at the medical device 130, a medical task. The selected one of the relevant medical configuration items is applied to perform the medical task. In a representative embodiment, the method 200, 300, 400 comprises receiving 312 a user rating at the medical device 130, updating the rating based on the user rating, and storing the updated rating at the server 110. In various embodiments, the rating is at least one of: a numerical rating (e.g., between 1-10, between 1 star and 5 stars, etc.), a letter grade (e.g., A-F), a number of likes, and a number of user subscribers.

In certain embodiments, the method 200, 300, 400 comprises receiving 316 a user subscription to the selected one of the relevant medical configuration items at the medical device 130 and updating 314 at least one of user preferences, a subscription list, and a medical configuration item from the plurality of medical configuration items stored at the server 110. In a representative embodiment, the method 200, 300, 400 comprises receiving 320 a user recommendation at the medical device 130 and transmitting 322 at least one of a notification of the user recommendation and the configuration item to the at least one user in response to the user recommendation. The user recommendation corresponds with a medical configuration item from the plurality of medical configuration items stored at the server 110. The user recommendation identifies at least one user.

In various embodiments, the list of relevant medical configuration items is displayed at a display 131 of the medical device 130. In certain embodiments, the method 200, 300, 400 comprises receiving 402 a user login at the medical device 130 and automatically retrieving 404 at least one medical configuration item from the plurality of medical configuration items based on the at least one of the user preferences, the subscription list, and the medical configuration item. In a representative embodiment, the method 200, 300, 400 comprises creating 202 a medical configuration item at the medical device 130 and transmitting 210 the created medical configuration item for storage with the plurality of medical configuration items at the server 110. In various embodiments, each of the plurality of medical configuration items is at least one of: imaging device operating parameters, an imaging examination template, an image measurement definition, and a medical report template.

In accordance with various embodiments of the invention, a system 100 comprises a server 110 operable to receive a request, transmitted over a network 120, to search a plurality of medical configuration items stored at the server 110. Each of the plurality of medical configuration items may be associated with a rating. Each of the plurality of medical configuration items is applicable to perform a medical task. The server 110 is operable to provide a list of relevant medical configuration items from the plurality of medical configuration items based on the search request. The relevant medical configuration items are listed in an order based on the rating. The server 110 is operable to receive a selection of one of the relevant medical configuration items provided in the list. The server 110 is operable to distribute the selected one of the relevant medical configuration items over the network 120.

In certain embodiments, the system 100 comprises a medical device 130 in communication with the server 100 over the network 120. The medical device 130 comprises a display 131 and is operable to provide the search request to the server 110, display the list of relevant medical configuration items at the display 131, provide the selection of the one of the relevant medical configuration items, and receive the selected one of the relevant medical configuration items from the server 110. In a representative embodiment, the medical device 130 is at least one of a medical imaging modality and a medical workstation. In various embodiments, the medical device 130 is operable to perform a medical task. The selected one of the relevant medical configuration items is applied to perform the medical task.

In a representative embodiment, the medical device 130 is operable to receive a user rating. The server 110 is operable to update the rating based on the user rating and store the updated rating. The rating is at least one of: a numerical rating (e.g., between 1-10, between 1 star and 5 stars, etc.), a letter grade (e.g., A-F), a number of likes, and a number of user subscribers. In various embodiments, the medical device 130 is operable to receive a user subscription to the selected one of the relevant medical configuration items. The server 110 is operable to update at least one of user preferences, a subscription list, and a medical configuration item from the plurality of medical configuration items stored at the server 110. In certain embodiments, the medical device 130 is operable to receive a user recommendation that identifies at least one user and corresponds with a medical configuration item from the plurality of medical configuration items stored at the server 110. The server 110 is operable to transmit at least one of a notification of the user recommendation and the configuration item to the at least one user in response to the user recommendation.

Various embodiments provide a non-transitory computer readable medium having a stored thereon, a computer program having at least one code section that is executable by a machine for causing the machine to perform steps 200, 300, 400 disclosed herein. Exemplary steps 200, 300, 400 may comprise searching 302 a plurality of medical configuration items stored at a server 110 in response to a received request. Each of the plurality of medical configuration items may be associated with a rating. Each of the plurality of medical configuration items may be applicable to perform a medical task. The steps 200, 300, 400 may comprise providing 304 a list of relevant medical configuration items from the plurality of medical configuration items based on the received request. The relevant medical configuration items may be listed in an order based on the rating. The steps 200, 300, 400 may comprise distributing 308 a selected one of the relevant medical configuration items over a network 120 in response to a received selection.

As utilized herein the term “circuitry” refers to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting.

Other embodiments of the invention may provide a computer readable device and/or a non-transitory computer readable medium, and/or a machine readable device and/or a non-transitory machine readable medium, having stored thereon, a machine code and/or a computer program having at least one code section executable by a machine and/or a computer, thereby causing the machine and/or computer to perform the steps as described herein for sharing, distributing, ranking, and searching medical device configuration items.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method, comprising:
receiving a request, transmitted over a network to a server, to search a plurality of medical configuration items stored at the server, wherein each of the plurality of medical configuration items is associated with a rating, and wherein each of the plurality of medical configuration items is applicable to perform a medical task;
providing, by the server, a list of relevant medical configuration items from the plurality of medical configuration items based on the search request, wherein the relevant medical configuration items are listed in an order based on the rating;
receiving a selection, at the server, of one of the relevant medical configuration items provided in the list; and
distributing, by the server, the selected one of the relevant medical configuration items over the network.

2. The method according to claim 1, wherein the request and the selection is provided by at least one user input device of a medical device.

3. The method according to claim 2, wherein the medical device is at least one of a medical imaging modality and a medical workstation.

4. The method according to claim 3, comprising performing, at the medical device, a medical task, wherein the selected one of the relevant medical configuration items is applied to perform the medical task.

5. The method according to claim 4, comprising:
receiving a user rating at the medical device,
updating the rating based on the user rating, and
storing the updated rating at the server.

6. The method according to claim 5, wherein the rating is at least one of:
a numerical rating,
a letter grade,
a number of likes, and
a number of user subscribers.

7. The method according to claim 4, comprising:
receiving a user subscription to the selected one of the relevant medical configuration items at the medical device, and
updating at least one of user preferences, a subscription list, and a medical configuration item from the plurality of medical configuration items stored at the server.

8. The method according to claim 4, comprising:
receiving a user recommendation at the medical device, wherein the user recommendation corresponds with a medical configuration item from the plurality of medical configuration items stored at the server, and wherein the user recommendation identifies at least one user, and
transmitting at least one of a notification of the user recommendation and the configuration item to the at least one user in response to the user recommendation.

9. The method according to claim 3, wherein the list of relevant medical configuration items is displayed at a display of the medical device.

10. The method according to claim 7 comprising:
receiving a user login at the medical device, and
automatically retrieving at least one medical configuration item from the plurality of medical configuration items based on the at least one of the user preferences, the subscription list, and the medical configuration item.

11. The method according to claim 3 comprising:
creating a medical configuration item at the medical device, and
transmitting the created medical configuration item for storage with the plurality of medical configuration items at the server.

12. The method according to claim 1, wherein each of the plurality of medical configuration items is at least one of:
imaging device operating parameters,
an imaging examination template,
an image measurement definition, and
a medical report template.

13. A system, comprising:
a server operable to:
receive a request, transmitted over a network, to search a plurality of medical configuration items stored at the server, wherein each of the plurality of medical configuration items is associated with a rating, and wherein each of the plurality of medical configuration items is applicable to perform a medical task;
provide a list of relevant medical configuration items from the plurality of medical configuration items based on the search request, wherein the relevant medical configuration items are listed in an order based on the rating;
receive a selection of one of the relevant medical configuration items provided in the list; and
distribute the selected one of the relevant medical configuration items over the network.

14. The system according to claim 13, comprising a medical device in communication with the server over the network, wherein the medical device comprises a display and is operable to:
provide the search request to the server,
display the list of relevant medical configuration items at the display,
provide the selection of the one of the relevant medical configuration items, and
receive the selected one of the relevant medical configuration items from the server.

15. The system according to claim 14, wherein the medical device is at least one of a medical imaging modality and a medical workstation.

16. The system according to claim 15, wherein the medical device is operable to perform a medical task, wherein the selected one of the relevant medical configuration items is applied to perform the medical task.

17. The system according to claim 13, wherein the medical device is operable to receive a user rating, wherein the server is operable to update the rating based on the user rating and store the updated rating, and wherein the rating is at least one of:
a numerical rating,
a letter grade,
a number of likes, and
a number of user subscribers.

18. The system according to claim 15, wherein the medical device is operable to receive a user subscription to the selected one of the relevant medical configuration items and the server is operable to update at least one of user preferences, a subscription list, and a medical configuration item from the plurality of medical configuration items stored at the server.

19. The system according to claim 15, wherein the medical device is operable to receive a user recommendation that identifies at least one user and corresponds with a medical configuration item from the plurality of medical configuration items stored at the server, and wherein the server is operable to transmit at least one of a notification of the user recommendation and the configuration item to the at least one user in response to the user recommendation.

20. A non-transitory computer readable medium having stored thereon, a computer program having at least one code section, the at least one code section being executable by a machine for causing the machine to perform steps comprising:
searching a plurality of medical configuration items stored at a server in response to a received request, wherein each of the plurality of medical configuration items is associated with a rating, and wherein each of the plurality of medical configuration items is applicable to perform a medical task;
providing a list of relevant medical configuration items from the plurality of medical configuration items based on the received request, wherein the relevant medical configuration items are listed in an order based on the rating; and
distributing a selected one of the relevant medical configuration items over a network in response to a received selection.
